(19) United States
(12) Patent Application Publication
(10) Pub. No.: US 2008/0000615 A1
(43) Pub. Date: Jan. 3, 2008

(54) Coolant cooling structure

(75) Inventors: Kazuo Hiroshima, Tokyo-shi (JP); Katsushi Sasaki, Nishikamo-gun (JP)

Correspondence Address: BIRCH STEWART KOLASCH & BIRCH, PO BOX 747, FALLS CHURCH, VA, 22040-0747, US

(73) Assignee: Mitsubishi Jidosha Kogyo Kabushiki Kaisha

(21) Appl. No.: 11/819,635

(22) Filed: Jun. 28, 2007

(30) Foreign Application Priority Data
Jun. 30, 2006 (JP) 2006-182532

(51) Int. Cl. B60H 1/00

(52) U.S. Cl. 165/41

(57) ABSTRACT

A coolant cooling structure has a skeleton which constitutes a part of a car body, and has a housing space inside, and a radiator core inside of which coolant flows, and which is housed in the skeleton.

### CROSS-REFERENCE TO RELATED APPLICATIONS

This application is based upon and claims the benefit of priority from prior Japanese Patent Application No. 2006-182532, filed Jun. 30, 2006, the entire contents of which are incorporated herein by reference.

### BACKGROUND OF THE INVENTION

1. Field of the Invention

The present invention relates to a coolant cooling structure of a car body provided with a midship engine rear wheel drive platform, for example.

2. Description of the Related Art

In a conventional automobile having a car body provided with a midship engine rear wheel drive platform (MR), a radiator core is placed in any one of the front and rear end portions of a car body. This kind of structure is disclosed in Japanese Patent No. 2689608.

However, since a radiator core is placed in one of the front and rear end portions of a car body as disclosed in the Japanese Patent No. 2689608, it is difficult to form a trunk compartment in the front or rear end portion of a car body where a radiator core is placed.

Thus, an automobile with a MR platform tends to be difficult to have a large space to house baggage.

### BRIEF SUMMARY OF THE INVENTION

It is an object of the present invention to provide a coolant cooling structure capable of providing a wide space to house baggage.

A coolant cooling structure of the present invention has a skeleton which constitutes a part of a car body and has a housing space inside, and a radiator core inside of which coolant flows and which is housed in the skeleton.

According to this structure, it is unnecessary to take particular space to house the radiator core. In the present invention, front and rear are determined along the back-and-forth direction of a car body.

In a preferable embodiment of the invention, the skeleton is a floor tunnel which is provided in a floor panel, extended in the back-and-forth direction of a car body, and given space capable of housing baggage inside.

According to this structure, a radiator can be placed under a floor panel, and a radiator can be easily installed.

In a preferable embodiment of the invention, there is provided a coolant passage through which coolant passed which has passed the radiator core flows. The coolant passage is provided near a tank containing a wiper cleaning liquid.

According to this structure, even when a car body having a coolant cooling structure according to the invention is used in a cold climate, the wiper cleaning liquid is prevented from freezing.

In a preferable embodiment of the invention, the radiator core is provided with a first tank into which a coolant to be cooled flows, a second tank placed opposite to the first tank, and a flat coolant pipe communicatively connecting the first and second tanks and inside of which the coolant flows, and placed in the skeleton to be extended long in one direction, crossing the back-and-forth direction of the car body, and defining an open space between the front end and a wall of the skeleton. The coolant pipe is placed inclined to the back-and-forth direction of the car body so that the front end faces the open space side when the radiator core is placed in the skeleton.

According to this structure, the coolant pipe is placed inclined to the back-and-forth direction of a car body so that the front end of the coolant pipe is placed on the open space side, and the coolant pipe is prevented from disturbing the flow of air.

In a preferable embodiment of the invention, there is further provided a housing which houses the radiator core, and a protected member placed along the back-and-forth direction of the car body.

According to this structure, it is unnecessary to provide a particular protective member to protect the protected member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an automobile provided with a coolant cooling structure according to an embodiment of the present invention;

FIG. 2 is an exploded perspective view of the cooling structure shown in FIG. 1;

FIG. 3 is a perspective view of a radiator core shown in FIG. 2 with parts broken away;

FIG. 4 is an enlarged fragmentary cross-sectional view of a F4 area indicated by a chain double-dashed line in FIG. 3;

FIG. 5 is a perspective view of a radiator unit shown in FIG. 2 housed in a floor tunnel;

FIG. 6 is a fragmentary cross-sectional view of a radiator unit shown in FIG. 2 housed in a floor tunnel, with the upper part of the floor tunnel partly broken away;

FIG. 7 is a schematic diagram showing a circulation route of coolant in a coolant cooling structure according to the present invention; and

FIG. 8 is a cross-sectional view of a part placed close to the lower end of a front glass in a second coolant passage shown in FIG. 7, viewed from the left side to right side of a car width.

### DETAILED DESCRIPTION OF THE INVENTION

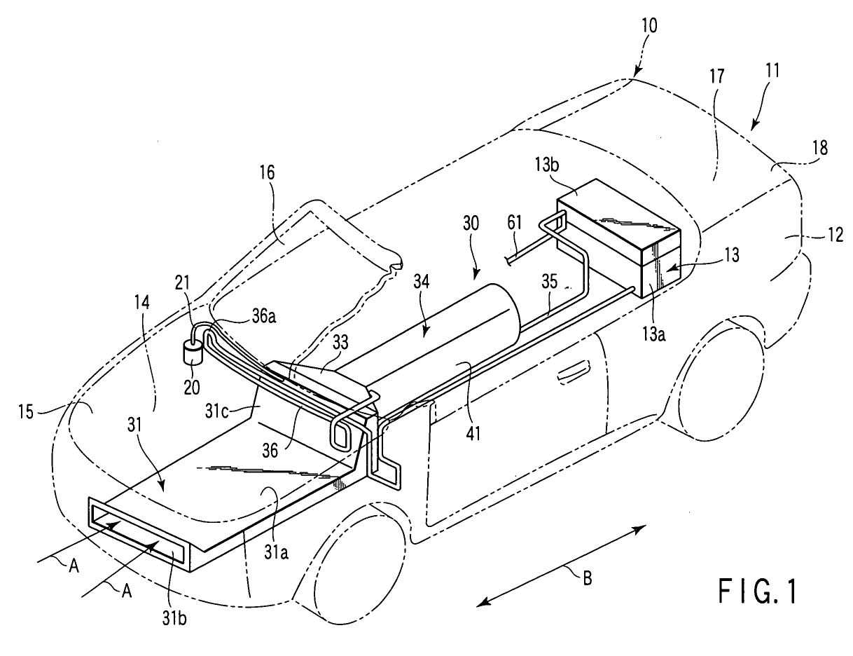

An embodiment of a coolant cooling structure according to the present invention will be explained hereinafter with reference to FIGS. 1 to 8. FIG. 1 is a perspective view of an automobile 11 provided with a coolant cooling structure 30. As shown in FIG. 1, a car body 12 of the automobile 11 is a midship engine rear wheel drive (MR) platform type. Therefore, an engine 13 is placed under a not-shown rear seat.

As shown in FIG. 1, a first trunk compartment 14 is formed in the front of a cabin in the car body 12. The first trunk compartment 14 is covered with a front hood 15. In the first trunk compartment 14, there are provided a tank 20 containing a cleaning liquid for a wiper, and a cleaning liquid pipe 21 for leading the cleaning liquid from the tank 20 to a front glass 16, for example. The cleaning liquid pipe 21 is extended close to the lower end of the front glass 16, for example.

A second trunk compartment 17 is formed in the rear of a not-shown cabin in the car body 12, that is, in the rear of the engine 13 in the car body 12. The second trunk compartment 17 is covered with a trunk lid 18.

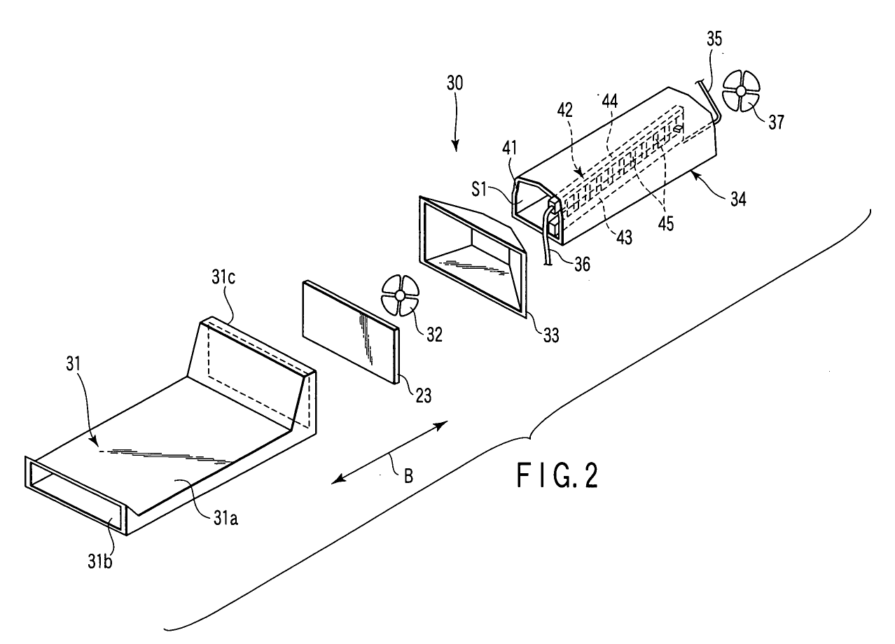

FIG. 2 is an exploded view of the cooling structure 30 shown in FIG. 1. As shown in FIG. 2, the cooling structure 30 has a duct 31, a first fan 32, a shroud 33 to house the first fan 32, a radiator unit 34, a floor tunnel 19, a first coolant passage 35, a second coolant passage 36, and a second fan 37.

The duct 31 has a main body 31a, an intake port 31b, and an exhaust port 31c. As shown in FIG. 1, the duct 31a is arranged with the thin side placed along the vertical direction of the car body 12. The main body 31a is shaped flat cylindrical, and extended from a part close to the front end to a part close to the rear end of the first trunk compartment 14. The duct 31 is placed under the first trunk compartment 14, for example.

As shown in FIG. 2, the intake port 31b is formed at one end of the main body 31a. The intake port 31b has an opening larger than the cross section of the main body 31a in order to take in sufficient air A. The exhaust port 31c is formed at the other end of the main body 31a. The exhaust port 31c has an opening large enough to include inside a condenser 23 for an air conditioner described later. As shown in FIG. 1, in the state that the duct 31 is housed in the car body 12, the intake port 31b is directed to the front of the car body, and the exhaust port 31c is directed toward the rear of the car body. As the main body 31a is shaped like a flat cylinder as described above, the duct 31 does not largely interfere with the housing space in the first trunk compartment 14.

The shroud 33 is placed in the rear of the exhaust port 31c of the duct 31. The shroud 33 is shaped like a cylinder to contain the first fan 32 inside. As shown in FIG. 1, the shroud 33 is shaped to have a cross section vertically crossing the back-and-forth direction B and gradually increasing toward the front side when the shroud 33 is housed in the car body 12.

As shown in FIG. 2, the radiator unit 34 has a housing 41 and a radiator core 42. The housing 41 is shaped like a cylinder containing the radiator core 42 inside. The housing 41 is made of resin or metal.

The front end of the housing 41 is connected to the rear end of the shroud 33. Therefore, the opening at the rear end of the shroud 33 has substantially the same shape as the opening at the front end of the housing 41. Namely, the shroud 33 has a cross section gradually reduced rearward in order to lead the air A taken in through the duct 31 to the housing 41.

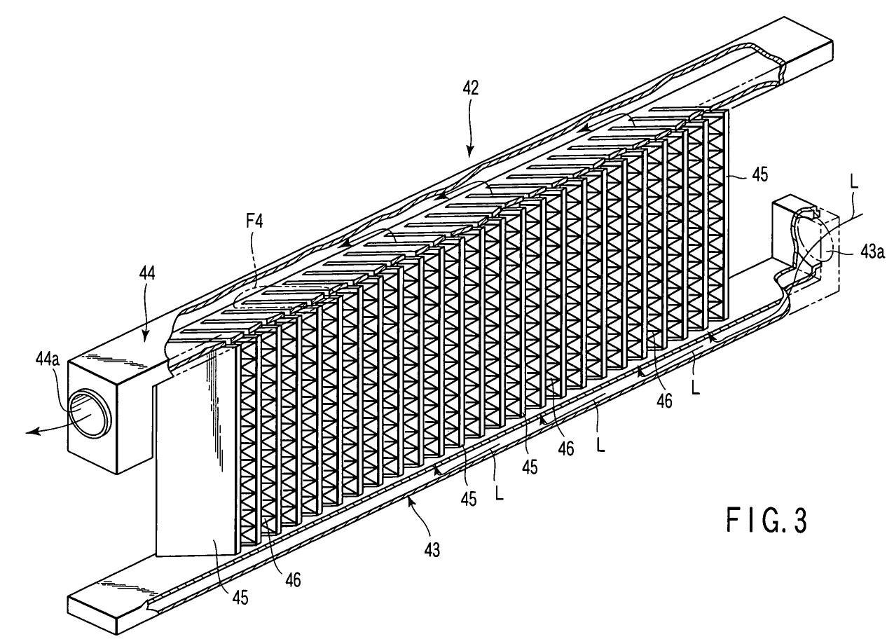

FIG. 3 a perspective view of the radiator core 42 with parts broken away. As shown in FIG. 3, the radiator core 42 has a first tank 43, a second tank 44, coolant pipes 45, and fins 46. The first tank 43 is shaped flat for example extending long in one direction. The second tank 44 is also shaped flat extending long in one direction as the first tank 43, and placed parallel to the first tank 43. The first and second tanks 43 and 44 are opposite to each other in their wide sides.

The coolant pipes 45 are placed side by side between the first and second tanks 43 and 44, along the back-and-forth direction of the first and second tanks 43 and 44. The coolant pipes 45 are placed substantially all over the areas of the first and second tanks 43 and 44. The coolant pipes 45 are shaped flat.

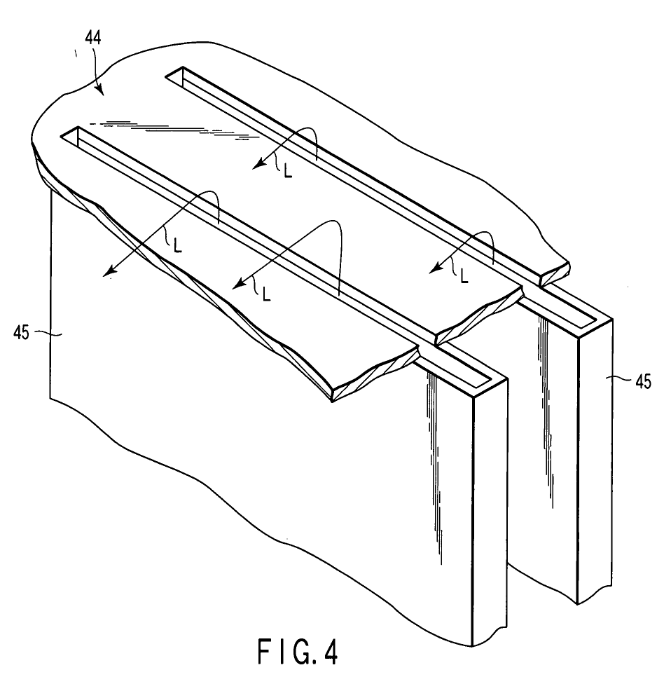

FIG. 4 is an enlarged fragmentary cross-sectional view of a F4 area indicated by a chain double-dashed line in FIG. 3. FIG. 4 illustrates a joint between the coolant pipes 45 and second tank 44, viewed from the inside of the second tank 44. As shown in FIG. 4, the coolant pipes 45 and second tank 44 are communicatively connected. Likewise, the first tank 43 is communicatively connected to the coolant pipes 45. As shown in FIG. 3, one end of the first tank 43 is provided with an inlet 43a to permit the inflow of coolant L to be cooled. An exhaust port 44a is formed at an end opposite to the inlet 43a in the second tank 44.

The positions of the coolant pipes 45 with respect to the first and second tanks 43 and 44 will be explained in detail. The fins 46 are placed between adjacent coolant pipes 45, and connected to the adjacent coolant pipes 45.

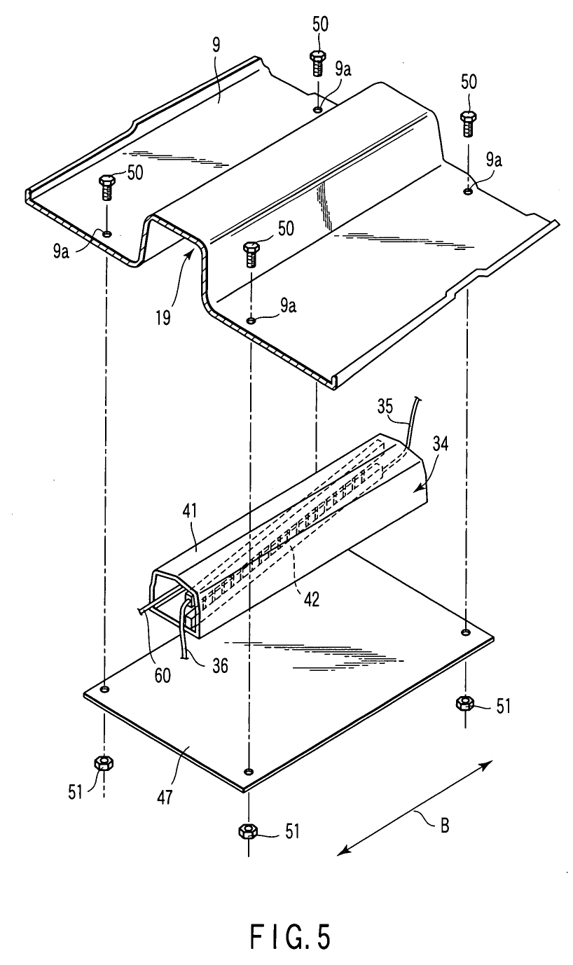

The radiator unit 34 is housed inside the floor tunnel 19, which constitutes the car body 12. Concrete explanation will be given on this point. FIG. 5 is a fragmentary perspective view of the radiator unit 34 housed in the floor tunnel 19. The floor tunnel 19 and floor panel 9 are partially shown in FIG. 5.

As shown in FIG. 5, the floor panel 9 is formed with the floor tunnel 19 to increase rigidity of the car body 12. The floor tunnel 19 is formed by bending the floor panel 9, for example. The floor tunnel 19 is opened downward to have a concave cross section, and extended along the back-and-forth direction B at substantially the middle in the width direction of the car body 12. The floor tunnel 19 is an example of a skeleton of a car body mentioned in the present invention.

FIG. 5 shows only the part of the floor tunnel 19 to house the radiator unit 34. For example, an area of the floor tunnel 19 ahead of the part to house the radiator unit 34 may be shaped to have a cross section vertically crossing the back-and-forth direction B and gradually decreasing toward the rear side to be capable of housing the shroud 33. Namely, the floor tunnel 19 may be formed in a shape capable of housing the shroud 33.

Through holes 9a are formed at four corners of the area of the floor panel 9 for housing the radiator unit 34. A plate member 47 for covering the opening of the floor tunnel 19 is placed under the area of the floor panel 9 for housing the radiator unit 34. As illustrated, the plate member 47 is fixed to the floor panel 9 with bolts 50 and nuts 51 in the state that the radiator 34 is housed in the floor tunnel 19. The plate member 47 is made of resin, for example. By fixing the plate member 47 to the floor panel 9, the radiator unit 34 is fixed in the floor tunnel 19.

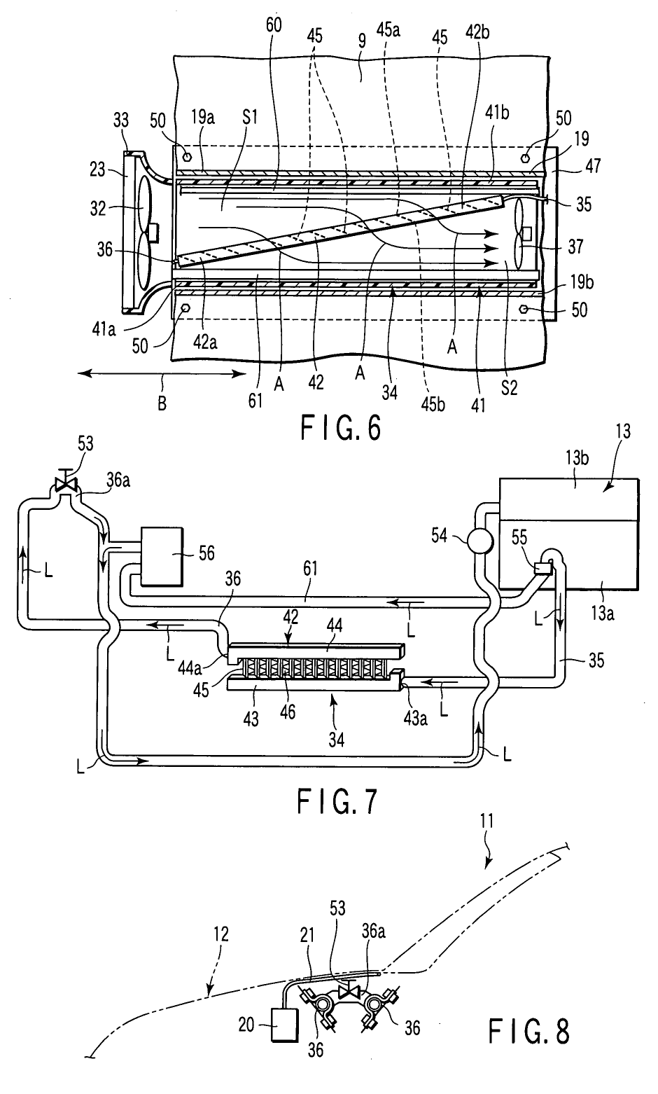

FIG. 6 is a plan view of the radiator unit 34 housed in the floor tunnel 19, with the upper part of the floor tunnel 19 partly broken away. As shown in FIG. 6, the radiator core 42 is placed so as to cross the back-and-forth direction B of the car body 12 in the housing 41. Concretely, the radiator core 42 is placed so that the front end 42a of the radiator core 42 is placed close to one side 41a of the wall of the housing 41 in the car width direction, and the rear end 42b of the radiator core 42 is placed close to the other side 41b of the wall of the housing 41 in the car width direction.

As a result, a first open space S1 is defined between the front end 42a of the radiator core 42 and the other side 41b of the wall of the housing 41. In other words, the first open space S1 is defined between the front end 42a of the radiator core 42 and the other side 19a of the wall of the floor tunnel 19 in the car width direction.

Similarly, a second open space S2 is defined between the rear end 42b of the radiator core 42 and one side 41a of the wall of the housing 41 in the car width direction. In other words, the second open space S2 is defined between the rear end 42b of the radiator core 42 and one side 19b of the wall of the floor tunnel 19 in the car width direction. These first and second open spaces S1 and S2 are parted by the radiator core 42.

Now concrete explanation will be given on the positions of the coolant pipes 45. As shown in FIG. 6, the coolant pipes 45 are connected to the first and second tanks 43 and 44 in a position inclined to the back-and-forth direction B, so that the front end 45a of the coolant pipe 45 is faced to the first open space S1 and the rear end 45b of the coolant pipe 45 is faced to the second open space S2 in the state that the radiator unit 34 is housed in the floor tunnel 19.

The second fan 37 is housed in the housing 41, for example, and placed in the rear of the radiator core 42.

FIG. 7 shows a circulation route of coolant L. As shown in FIG. 7, the first coolant passage 35 leads the coolant L having flowed in and cooled the engine 13 to the radiator core 42. The first coolant passage 35 communicatively connects a cylinder block 13a of the engine 13 to the inlet 43a of the first tank 43 of the radiator core 42, for example.

The second coolant passage 36 is communicatively connected to the radiator core 42 and cylinder head 13b, and leads the coolant L cooled by the radiator core 42 to the cylinder head 13b. The second coolant passage 36 will be concretely explained.

As shown in FIG. 1, a part of the second coolant passage 36 is placed just like folding back in the car width direction in the area near the front end of the front glass 16. Namely, a part of the second coolant passage 36 passes near the cleaning liquid pipe 21 and tank 20, and extends from the left end to the right end in the car width direction. A part of the second coolant passage is extended to the left end, after folding back at the right end.

FIG. 8 is a cross-sectional view of a part placed close to the lower end of the front glass 16 in the second coolant passage 36, viewed from the left side to right side of a car width. FIG. 8 shows the arrangement of the folded part 36a of the second coolant passage 36, cleaning liquid pipe 21, tank 20, and second coolant passage 36. As illustrated, the folded part 36a at the right end in the car width direction is projected upward, and becomes the highest in the first and second coolant passages 35 and 36 and the radiator core 42, that is, in the passage through which the coolant L flows, when the automobile 11 is on a horizontal road.

As shown in FIG. 7, an air vent valve 53 is incorporated in the folded part 36a of the second coolant passage 36. The air vent valve 53 is used to exhaust the gas stayed in the first and second coolant passages 35 and 36 and the radiator core 42.

A water pump 54 is provided immediately before the cylinder head 13b in the second coolant passage 36. A reference number 61 in FIG. 7 denotes a third coolant passage. A third coolant passage 61 is communicatively connected to an exhaust port of the cylinder block 13a through a thermostat 55. The exhaust port exhaust the coolant L into the first coolant passage 35. The third coolant passage 61 is communicatively connected to the heater 56. As shown in FIG. 6, the third coolant passage 61 runs inside the housing 41. The heater 56 is communicatively connected to the downstream of the air vent valve 53 in the second coolant passage 36.

A reference number 23 in FIG. 6 denotes a condenser for an air conditioner. As illustrated, the condenser 23 for an air conditioner is housed in the shroud 33 for example, and placed immediately before the first fan 32.

As shown in FIG. 5, the housing 41 contains wiring/piping 60 extending in the back-and-forth direction B of the car body 12. The wiring/piping 60 is an example of protected member mentioned in the present invention.

Next, explanation will be given on the function of the coolant cooling structure 30. As shown in FIG. 7, the coolant L having cooled the engine 13 by flowing in the engine 13 is led to the radiator core 42, passing through the first coolant passage 35. As shown in FIG. 3, the coolant L led to the radiator core 42 flows into the first tank 43. The coolant L having flowed into the first tank 43 flows into the second tank 44, passing through the coolant pipe 45.

In this time, the first and second fans 32 and 37 are driven, and as a result, air A is taken in from the intake port 31b of the duct 31 as shown in FIG. 1. As shown in FIG. 6, the air A taken in through the duct 31 passes through the condenser 23 for an air conditioner, and flows into the housing 41.

As described above, each coolant pipe 45 is inclined to the back-and-forth direction B of the car body 12, and the air A passes smooth between the coolant pipes 45. Therefore, the coolant L is cooled by the air A while passing through the coolant pipes 45.

The coolant L passing through the coolant pipes 45 is exhausted into the second coolant passage 36 through the exhaust port 44a of the second tank 44. The coolant L flowing in the second coolant passage 36 has a temperature of about 80 degrees even after passing through the radiator core 42. Therefore, the coolant L warms up the cleaning liquid pipe 21 and tank 20, while passing near the cleaning liquid pipe 21 and tank 20. As a result, even when the automobile 11 is used in a cold climate, for example, the cleaning liquid contained in the cleaning liquid pipe 21 and tank 20 is prevented from freezing.

As shown in FIG. 7, the coolant L passing near the front glass 16 is led to the cylinder head 13b by the water pump 54. Air bubbles produced while the coolant L is flowing are released to the outside through the air vent valve 53.

In the coolant cooling structure 30 configured as described above, the radiator unit 34 is housed in the floor tunnel 19. Therefore, the radiator unit 34 is not placed in the front end or rear end part of the car body 12. The first trunk compartment 14 can be formed in the front end part of the car body 12, and the second trunk compartment 17 can be formed in the rear end part of the car body 12. Space to house baggage can be increased in the car body 12.

Further, by using the floor tunnel 19 formed to ensure the rigidity of the car body 12 as a skeleton to contain a radiator unit, it is unnecessary to take particular space to contain the radiator unit 34. This simplifies the cooling structure 30.

As the second coolant passage 36 runs near the cleaning liquid pipe 21 and tank 20, even when the automobile 11 is used in cold climate areas, the cooling liquid is prevented from freezing.

As the radiator core 42 is placed inclining to the back-and-forth direction B of the car body 12, air can be efficiently applied to the radiator core 42 even in the narrow floor tunnel 19.

As the coolant pipe 45 is inclined to the back-and-forth direction B of the car body 12, the air A flows smoothly between the coolant pipes 45. As a result, the coolant L can be efficiently cooled.

Further, as the housing 41 contains the wiring/piping 60 extending in the back-and-forth direction B of the car body 12, the housing 41 functions as a protective member for the wiring/piping 60. Therefore, the wiring/piping 60 does not need a particular protective member. This can reduce the cost of the automobile 11.

Front and rear mentioned in the present invention are determined along the back-and-forth direction of a car body. A car body in the present invention is not limited to a MR type.

In this embodiment, the duct 31 takes in the air A from the front end of the car body, but the invention is not to be limited to this. For example, air may be taken in from the side of the car body 12.

A floor tunnel is adopted as an example of a skeleton in this embodiment, but the invention is not to be limited to this. For example, a side member having a hollow or open cross section may be used as an example of a skeleton.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A coolant cooling structure comprising:
a skeleton which constitutes a part of a car body, and has a housing space inside; and
a radiator core inside of which coolant flows, and which is housed in the skeleton.

2. The coolant cooling structure according to claim 1, wherein the skeleton is a floor tunnel which is provided in a floor panel, extended in the back-and-forth direction of a car body, and given space capable of housing baggage inside.

3. The coolant cooling structure according to claim 1, further comprising a coolant passage through which coolant which has passed the radiator core flows, the coolant passage being provided near a tank containing a wiper cleaning liquid.

4. The coolant cooling structure according to claim 1, wherein the radiator core is provided with a first tank into which a coolant to be cooled flows, a second tank placed opposite to the first tank, and a flat coolant pipe communicatively connecting the first tank and second tank and inside of which the coolant flows, and placed in the skeleton to be extended long in one direction, crossing the back-and-forth direction of the car body, and defining an open space between the front end and a wall of the skeleton; and
the coolant pipe is placed inclined to the back-and-forth direction of the car body so that the front end faces the open space side when the radiator core is placed in the skeleton.

5. The coolant cooling structure according to claim 1, further comprising a housing which houses the radiator core, and a protected member placed along the back-and-forth direction of the car body.
